(19) United States
(12) Patent Application Publication
(10) Pub. No.: US 2016/0358136 A1
(43) Pub. Date: Dec. 8, 2016

(54) PORTAL INTERFACE FOR ESTABLISHMENT AND MANAGEMENT OF CONFIRMED PAYMENT ACCOUNT

(71) Applicant: PAYPAL, INC., San Jose, CA (US)

(72) Inventors: Michael Charles Todasco, Santa Clara, CA (US); Oktay Dogramci, San Jose, CA (US); Hemal Doshi, San Jose, CA (US)

(21) Appl. No.: 14/985,104

(22) Filed: Dec. 30, 2015

Related U.S. Application Data
(60) Provisional application No. 62/170,085, filed on Jun. 2, 2015.
(60) Provisional application No. 62/201,811, filed on Aug. 6, 2015.

(51) Int. Cl. G06Q 20/10; G06Q 30/02

(52) U.S. Cl. CPC G06Q 20/10; G06Q 30/0279

(57) ABSTRACT

There are provided systems and methods for an entity portal interface for establishment and management of a confirmed entity payment account. A payment provider may offer account services to an entity. The entity may wish to solicit donations or other funding. In order to verify the entity is a recognized entity and that the entity actually requires the funding for the stated purpose, the payment provider may require entity information, such as identification, funding goals, information about the funding purpose, or other documentation. The payment provider may further require the entity to provide a financial account, which the payment provider may confirm is linked to the entity and not another fraudulent party. The payment provider may establish the account and assist the entity in receiving donations and funding.

### CROSS REFERENCE TO RELATED APPLICATIONS

The present application claims priority to U.S. Provisional Patent Application Ser. No. 62/170,085, filed Jun. 2, 2015, and U.S. Provisional Patent Application 62/201,811, filed Aug. 6, 2015, which are both incorporated by reference in their entirety.

### TECHNICAL FIELD

The present application generally relates to online website portals used to establish accounts and more specifically to a portal interface for establishment and management of a confirmed entity payment account.

### BACKGROUND

Online payment accounts may be used for may purposes, including sending and receiving payments, as well as account management and disbursements (e.g., withdrawals and deposits) to other financial accounts (e.g., bank accounts, investment accounts, etc.). An entity may wish to establish an online payment account for the purpose of receiving contributions from other online users. Payment providers may wish to provide use of payment accounts to entities, as well as incentives and benefits to the entities, such as reduced transaction fees, options to allow for contributions to be added to transactions, and increased visibility of entities. In other embodiments, the payment providers may wish to allow for other entities, such as individual users, upstart businesses, filmmakers, engineers, podcast makers or other types of casters, or other entities to solicit donations and/or funding for other enterprises. However, many payment providers that service such payment accounts may wish to prove the identity of the entity soliciting the funding. For example, bad actors may hold themselves out to be a certain entity fraudulently to receive the funding, including benefits that the payment provider or governments may provide to certain types of entities. Without the payment provider being able to establish that the entity is actually real and properly soliciting/using funding, the payment provider may not offer such payment account services due to risk of fraud.

### BRIEF DESCRIPTION OF THE DRAWINGS

FIG. 1 is a block diagram of a networked system suitable for implementing the processes described herein, according to an embodiment;

FIG. 2A is an exemplary portal interface to confirm a charitable status and bank account for an entity, according to an embodiment;

FIG. 2B is an exemplary portal interface to provide an employer identification number (EIN) for a charity, according to an embodiment;

FIG. 2C is an exemplary portal interface to provide bank account information for a charity, according to an embodiment;

FIG. 2D is an exemplary portal interface to provide charitable status information for a charity, according to an embodiment;

FIG. 3 is an exemplary system environment having an entity's device establishing a confirmed entity payment account with a payment provider, according to an embodiment;

FIG. 4 is an exemplary process flowchart for to a portal interface for establishment and management of a confirmed entity payment account, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for to a portal interface for establishment and management of a confirmed entity payment account. Systems suitable for practicing methods of the present disclosure are also provided.

A payment provider may offer account services to various entities, including personal users, merchants, companies, and charities. The accounts with the payment provider may correspond to payment accounts, where a holder of the account may send and receive payments, funding, donations, and other financial transactions. For example, the payment account may be utilized by the charity in order to receive charitable donations from one or more users through processes available with the payment provider, including direct payments from another payment account or bank account. The charitable account may further allow donors to donate through credit card or other funding source that may be more vulnerable to fraud. Moreover, the charitable payment account may further be utilized with processes offered by the payment provider to the charity, including payment processes and mechanisms. For example, the payment provider may include one or more processes to provide a donation link, executable process, and/or computer code that allow the charity to establish a donation process on a website, in an application, on a social networking service, and/or through various electronic messaging platforms. Such processes may also include real-world processes, including donations through payments and credit card transactions at physical locations (e.g., a credit card magnetic card reader associated with a chartable device for the charity or a merchant device). Moreover, the charitable account may provide one or more benefits to the charity, including a reduced transaction fee rate when processing transactions with the payment provider over another type of payment account, such as a business payment account.

In order to establish a payment account, the payment provider may provide a website used for account registration, which may include one or more registration interfaces and/or portals. One such registration portal may be utilized for charitable entities, such as a charity that receives donates for one or more causes. The payment provider may provide the portal for registration and management of a payment account associated with the charitable entity. Although a “payment provider” and a “charity” or “charitable entity” are referred to herein, such embodiments are merely meant to be demonstrative and not limiting. Thus, other services providers may be utilized as a “payment provider,” which may provide account services to various entities. Moreover, different entities than a “charity” or “charitable entity” may require account services, which may be governed by local law and receive benefits by nature of their legal status, such as types of corporations, companies, partnerships, etc. Thus, other types of entities that receive benefits by nature of a special legal status may require vetting by a service provider in a similar manner or modified accordingly to those described herein, such as non-profit entities that may be entitled to various legal benefits, statuses, and/or taxation structures and rates. For example, and similar to a charity, a non-profit entity may receive various benefits from the payment provider and/or government through the status of the entity as a non-profit. Thus, the non-profit entity may also wish to receive account services provided to non-profit entities.

When the charitable entity accesses the website of the payment provider and indicates that the charitable entity would like to establish a payment account for the charitable entity, the payment provider may direct the charitable entity to the portal for registration. The payment account for the charitable entity may allow the charitable entity to receive funding and donations, as well as provide payments to associated entities (e.g., co-charities, businesses assisting the charity, workers and management, governments, etc.) and benefactors of the charitable entity (e.g., causes, people, and entities with their associated business structures). The portal may provide an interface, which may include one or more webpages, webpage elements, forms, and other mechanisms to allow the charitable entity to input information necessary to establish the charitable payment account for the charitable entity. For example, the charitable entity may select a login name, password, PIN, or other identification and authentication information allowing for identification and access of the charitable payment account. In other embodiments, the charity may already have a payment account with the payment provider, such as a business payment account, and may wish to provide charitable information to the payment provider in order to change the status of the payment account and/or receive discounted rates and taxation status/services associated with a charitable payment account.

Thus, the payment provider may require charity information from the charitable entity to establish the charitable entity as a valid charity under governing law. Establishment of the charitable entity as a valid charity may allow for the charitable entity to receive certain benefits with the payment provider and under governing law for the payment account. For example, law governing receipt and disbursement of funding from the charity may affect taxation of payments, tax structures, and/or taxable effects of managing the payment account for the payment provider. Additionally, the payment provider may provide incentives for charities to utilize the payment provider for payment services, which may not be offered to other personal users, merchants, and/or businesses. For example, charities may receive a discounted transaction fee when using the payment provider, may receive additional advertisement and public awareness campaigns, may enroll in charitable contribution funds with other charities, and may provide options for charitable contributions from purchasers during processing of transactions with sellers. The payment provider may also provide for benefits with direct sellers that sell items associated with the charity or to benefit the charity. In order to prevent fraudulent activity where anon-charitable entity acts like a charitable entity to receive the aforementioned benefits, the payment provider may utilize the portal to provide one or more interfaces used to collect charity information from the charitable entity. Such requirements by the payment provider may also be required under law to verify by the payment provider in order for the payment provider to offer the benefits and/or statuses associated with a charitable entity.

The charity information requested by the payment provider may include at least an employer identification number (EIN), a financial account for the charity entity, and at least one status document that identifies the charitable entity as a charity under laws governing the charity. The charity information may also include additional information, such as an email account, phone number, address, and/or other contact information. Moreover, additional charity information may include profile information, linked sellers and direct sellers, and/or other information necessary to establish a payment account for the charitable entity. Using the charity information, the payment provider may establish the charitable payment account. Additionally, the payment provider may utilize the EIN and the status document(s) to determine whether the charity is properly licensed, recognized, or established as a charity under governing law, for example, using a database of recognized charities and/or established charities or using available information of laws governing charities in the location associated with the charity. The payment provider may include charitable entity information stored to one or more databases, such as parameters used to determine whether an entity is a charity, and/or may interact with one or more outside resources to determine whether the entity is a charity. For example, various governmental agencies, including the IRS, may include information used to determine whether an entity is a charity. Such data may be accessible from one or more online resources, such as a website of the governmental agency.

Moreover, the payment provider may also utilize the financial account information for the charity to determine whether the financial account is actually linked to the charity to prevent fraud by an actor imitating the charity. Thus, the payment provider may be required to authenticate that the financial account is linked to the charity, for example, using available information from the financial institution, deposits, and/or other authentication mechanisms. The payment provider may determine whether the payment account is linked to the charity through data accessible for the charity and whether payment account funds are released or utilized. Moreover, the payment account funds may be traced to ensure that the funds are being utilized for a charitable cause and/or on payments and purchases required by the charity (e.g., payment for employees, purchase of goods for the charitable cause, etc.). In this regard, the bank and bank account for the entity may provide an additional layer of security by insuring that the entity is who the entity is holding themselves out to be. For example, publicly available and/or fake information may be provided to make a fraudulent entity appear charitable. However, tying the entity to a bank account used by the charity may insure that funds used by the entity are actually being used for charitable purposes. Moreover, the bank account may provide additional authentication and identification of the entity, for example, through legal documents and information provided and verified by the entity when establishing the bank account. Moreover, access to the bank account by the payment provider may be utilized to freeze or retrieve assets of the entity where the entity is acting fraudulently and/or is not a charity (or using the funds for a charitable purpose).

The laws governing the charity may depend on the location of the charity and/or the charities activities, such as fund raising, disbursement of funding, headquarters of operation, and/or place of foundation/incorporation. Thus, the required charity information may be different depending on the location associated with the charity. In such embodiments, the payment provider may utilize different information for confirming the charities, such as compliance laws, account review, charity registrations, monitoring, and/or other confirmation processes. Thus, the requirements and processing performed by the payment provider when determining whether the entity is a charity may be dependent on a location, region, jurisdiction, or other defined area affecting charitable status. The payment provider may therefore be required to determine laws governing the charity, such as where the charity operates and/or is locations, and may alter the processing mechanisms to confirm the entity is a charity based on the location's laws.

Once the charitable entity's status as a charity is confirmed, the payment provider may allow the charitable entity to use the payment account. Thus, the payment provider may offer one or more management interfaces, allowing for the charitable entity to send and receive money using the payment provider. The payment provider may also allow for the charitable entity to register with direct sellers associated with the charitable entity that also utilize the payment provider in order to receive funding from the direct sellers to the charitable entity's payment account. The payment provider may also allow for the charitable entity to advertise within marketplaces and through transactions for donations, or join donation funds that include other charitable entities. Moreover, the payment provider may establish a profile for the charitable entity allowing for searching and review of the charitable entity by parties that wish to donate.

The payment provider may further report the entity as a charity to one or more other entities reviewing the charity and/or the charitable payment account for the charity. For example, the payment provider may inform a governmental agency, such as the IRS, that the payment account is for a charity in order to properly tax payment account funds, payments, and donations. Additionally, such information may be provided to donors for purposes of the donors' taxes and records. The payment provider may further provide merchants and other entities transacting with the charity of the status of the charity and the charitable payment account, which may be used during transaction processing.

The payment provider may provide ongoing maintenance of the payment account, which may include determinations of whether the entity is maintaining their charitable status. For example, the payment provider may include one or more processes to monitor information for the entity, such as an EIN, bank account, and/or charitable contributions, to determine that the entity is still a charity under applicable law. Such monitoring may occur continuously, and/or at specified intervals, such as monthly, yearly, or according to other predetermine criteria by the payment provider. If the payment provider determines that the entity is no longer entitled to charitable status under applicable law, the payment provider may remove the charitable designation from the entities payment account and/or disable benefits provided to a charity by the payment provider and used with the payment account. For example, the entity may longer be provided reduced transaction rates and tax rates/benefits through the payment account if the entity no longer has a charitable status under applicable law.

In other embodiments, the payment provider may instead confirm the identity and status of another entity, such as a user, merchant, and/or business. In this regard, the payment provider may require other information in order to validate a payment account and/or a request for funding by the entity and the entity itself. For example, a student requesting money to a payment account in order to purchase one or more items from school may be required to provide a school identification card, course syllabus, enrollment verification, and/or other information that may prove that the student is enrolled in school. In other embodiments, the student may also be required to demonstrate that they actually need the funding for the stated purpose. For example, if the funding is for a book for a class, the student may be required to show that the student is enrolled in the case and/or that the class requires that book. Other examples of required information for specific entities may include funding for a podcaster by demonstrating that the entity does prepare the podcast and/or that funding is required to maintain the podcast. Where funding is for hosting of an event, the entity may be required to show that the event is scheduled and/or the entity has taken steps to execute the event, and that the entity is the host of the event. Entities may also correspond to those providing a specific purpose, such as an entity performing genealogy mapping, server services, sports and sporting events/services, gaming/media services, religious services, broadcasting and news services, musical services, or other types of desirable services. Thus, the payment provider may require the entity to provide proof that the entity is capable of providing the service and/or verify and identity of the entity where the identity is important for the value of the service provided (e.g., the musical service is provided by a well-known musician, etc.)

Other types of entities and corresponding required information may include designers of items, including video game designers, entertainers, media creators, manufacturers, and/or engineers. Thus, such entities may be required to present credentials, and/or may be required to show that they have the capacity to provide the item. In such embodiments, the payment provider may further allow for such entities to provide the item to the funding users once funding is complete and/or the item is produced. Additionally, the payment provider may determine and request an amount for funding, and make sure that the solicitation for funding is ended when the funding goal is reached. Thus, any excess funding may be returned to the funding users. In other embodiments, the payment provider may instead provide the excess funding to a charity of choice by the funding users, the entity requesting funding, and/or the payment provider.

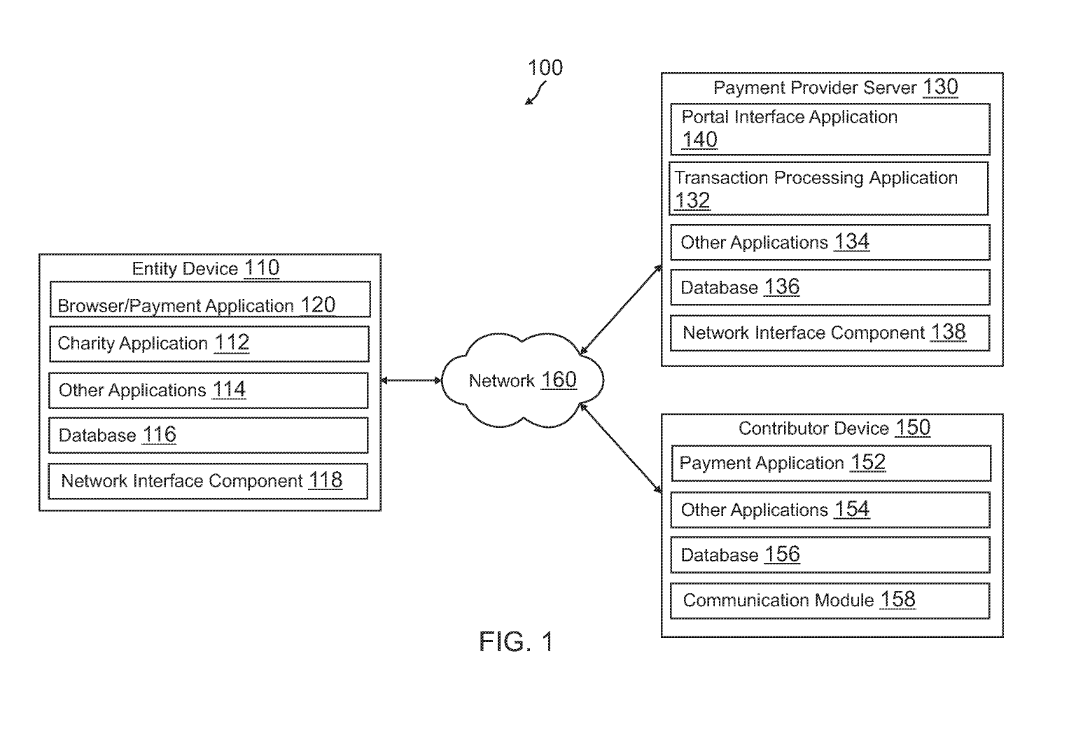

FIG. 1 is a block diagram of a networked system 100 suitable for implementing the processes described herein, according to an embodiment. As shown, system 100 may comprise or implement a plurality of devices, servers, and/or software components that operate to perform various methodologies, in accordance with the described embodiments. Exemplary devices and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes an entity device 110, a payment provider server 130, and a contributor device 150 in communication over a network 160. A charitable entity may be associated with entity device 110 and may request to establish a charitable payment account with payment provider server 130. Payment provider server 130 may establish the account using charity information for the charitable entity. Additionally, the charitable entity may receive donations and funding, for example, from a user associated with contributor device 150.

Entity device 110, payment provider server 130, and contributor device 150 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

Entity device 110 may be implemented as a communication device that may utilize appropriate hardware and software configured for wired and/or wireless communication with payment provider server 130 and/or contributor device 150. For example, in one embodiment, entity device 110 may be implemented as a personal computer (PC), a smart phone, laptop/tablet computer, wristwatch with appropriate computer hardware resources, eyeglasses with appropriate computer hardware (e.g. GOOGLE GLASS®), other type of wearable computing device, implantable communication devices, and/or other types of computing devices capable of transmitting and/or receiving data, such as an IPAD® from APPLE®. Although a communication device is shown, the communication device may be managed or controlled by any suitable processing device. Although only one communication device is shown, a plurality of communication devices may function similarly.

Entity device 110 of FIG. 1 contains a browser/payment application 120, a charity application 112, other applications 114, a database 116, and a communication module 118. Browser/payment application 120 and other applications 114 may correspond to executable processes, procedures, and/or applications with associated hardware. In other embodiments, entity device 110 may include additional or different modules having specialized hardware and/or software as required.

Browser/payment application 120 may correspond to one or more processes to execute modules and associated devices of entity device 110 to establish a payment account for a charity associated with entity device 110 and initiate, receive, and/or process/complete funding transactions using a payment account associated with the charity for entity device 110. In this regard, browser/payment application 120 may correspond to specialized hardware and/or software utilized by entity device 110 to access payment provider server 130 and request that a charitable payment account be established for the charity. In various embodiments, browser/payment application 120 may include a general browser application configured to retrieve, present, and communicate information over the Internet (e.g., utilize resources on the World Wide Web) or a private network. For example, browser/payment application 120 may provide a web browser, which may send and receive information over network 160, including retrieving website information, presenting the website information, and/or communicating information to the website, including payment information. However, in other embodiments, browser/payment application 120 may include a dedicated application of payment provider server 130.

Browser/payment application 120 may access one or more portal interfaces for use in establishing and verifying that the entity using entity device 110 is a charity. For example, the portal interfaces may request information on the charity and charity's documents for use in proving that the entity is a charity. The information may include governmental issued identifiers used to identify the entity as a charity, as well as documents showing that the charity is contributing to a cause and otherwise operating as a charitable entity. Moreover, the portal interfaces may further request information on a bank account of the charity that may receive donations through payment provider server 130, for example, deposits and payouts from a charitable bank account for the charity with payment provider server 130. Thus, browser/payment application 120 may further communicate information necessary to establish the charitable payment account, which may include charity information, such as an EIN, tax information, charity status documentation, and/or bank account information through the portal interfaces. The portal interfaces may be accessible through a website or a dedicated application, and may correspond to website forms and interfaces having one or more website fields for entry of data processed by payment provider server 130. The charity may also provide additional registration information for a charitable payment account where one is not yet established, such as contact information and/or profile information. Once a charitable payment account is established or verified for the charitable entity associated with entity device 110, browser/payment application 120 may further be used to be used to access the account, view statuses of the account, send and receive money using the account, and update the account. For example, the charitable payment account may be used to receive donations from one or more entities.

Charity application 112 may correspond to one or more processes to execute modules and associated specialized hardware of entity device 110 that may be used by the charitable entity associated with entity device 110 to manage charitable aspects of the charitable entity. In this regard, charity application 112 may include charity information for the charitable entity, and may manage the charitable and funding for the charity. Charity application 112 may be used to provide charitable information to payment provider server 130, for example, to establish a charitable payment account. Additionally, charity application 112 may provide interfaces and/or resources to receive donations from one or more other entities, such as a website of the charity that may allow donors to access the website and provide donations, for example, to the charitable account provided by payment provider server 130. Additionally, charity application 112 may further provide donations through one or more real-world payment sources, such as point of sale devices and payment processing terminals. In various embodiments, the payment processes to provide donations by donors utilized by charity application 112 may be provided by payment provider server 130.

In various embodiments, one or more the discussed hardware and/or software features of browser/payment application 120 and charity application 112 may be included in the same module.

In various embodiments, entity device 110 includes other applications 114 as may be desired in particular embodiments to provide features to entity device 110. For example, other applications 114 may include security applications for implementing client-side security features, programmatic client applications for interfacing with appropriate application programming interfaces (APIs) over network 160, or other types of applications. Other applications 114 may also include email, texting, voice and IM applications that allow a user to send and receive emails, calls, texts, and other notifications through network 160. In various embodiments, other applications 114 may include financial applications, such as banking, online payments, money transfer, or other applications. Other applications 114 may also include other location detection applications, such as a mapping, compass, and/or GPS application. Other applications may include social networking applications and/or merchant applications. Other applications 114 may include device interfaces and other display modules that may receive input and/or output information. For example, other applications 114 may contain software programs, executable by a processor, including a graphical user interface (GUI) configured to provide an interface to the user.

Entity device 110 may further include database 116 stored to a transitory and/or non-transitory memory of entity device 110, which may store various applications and data and be utilized during execution of various modules of entity device 110. Thus, database 116 may include, for example, identifiers such as operating system registry entries, cookies associated with browser/payment application 120 and/or other applications 114, identifiers associated with hardware of entity device 110, or other appropriate identifiers, such as identifiers used for payment/user/device authentication or identification. Database 116 may include information for the charity, such as an EIN for the charity and/or other documents for the charity that may be used to confirm that a payment account is used for charitable purposes. Additionally, information for the charitable payment account may be stored to database 116.

Entity device 110 includes at least one communication module 118 adapted to communicate with payment provider server 130 and/or contributor device 150. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Payment provider server 130 may be maintained, for example, by an online payment service provider, which may provide payment services and/or processing for financial transactions on behalf of users. In this regard, payment provider server 130 includes one or more processing applications which may be configured to interact with entity device 110, contributor device 150, and/or another device/server to facilitate payment for a transaction, including establishment of payment accounts and generation of a shared authentication having an authentication mechanism allow other users than a primary use to utilize the payment account during transaction processing. In one example, payment provider server 130 may be provided by PAYPAL®, Inc. of San Jose, Calif., USA. However, in other embodiments, payment provider server 130 may be maintained by or include a credit provider, financial services provider, financial data provider, and/or other service provider, which may provide payment services to user 102.

Payment provider server 130 of FIG. 1 includes portal interface application 140, a transaction processing application 132, other applications 134, a database 136, and a network interface component 138. Portal interface application 140, transaction processing application 132, and other applications 134 may correspond to executable processes, procedures, and/or applications with associated hardware. In other embodiments, payment provider server 130 may include additional or different modules having specialized hardware and/or software as required.

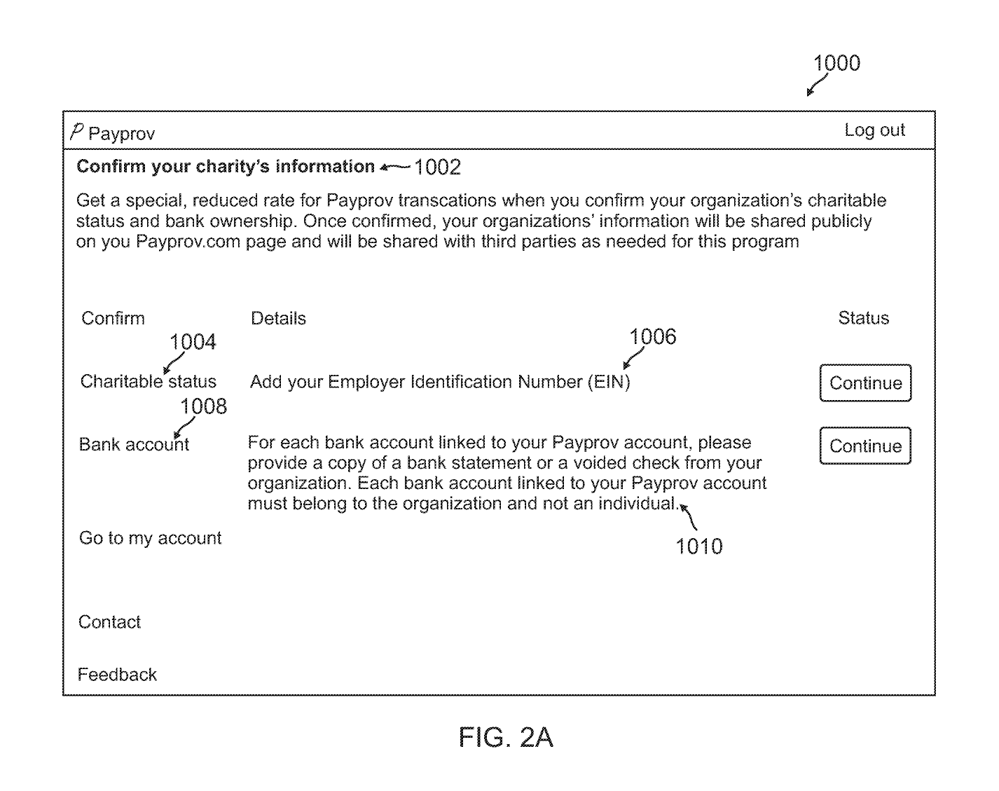

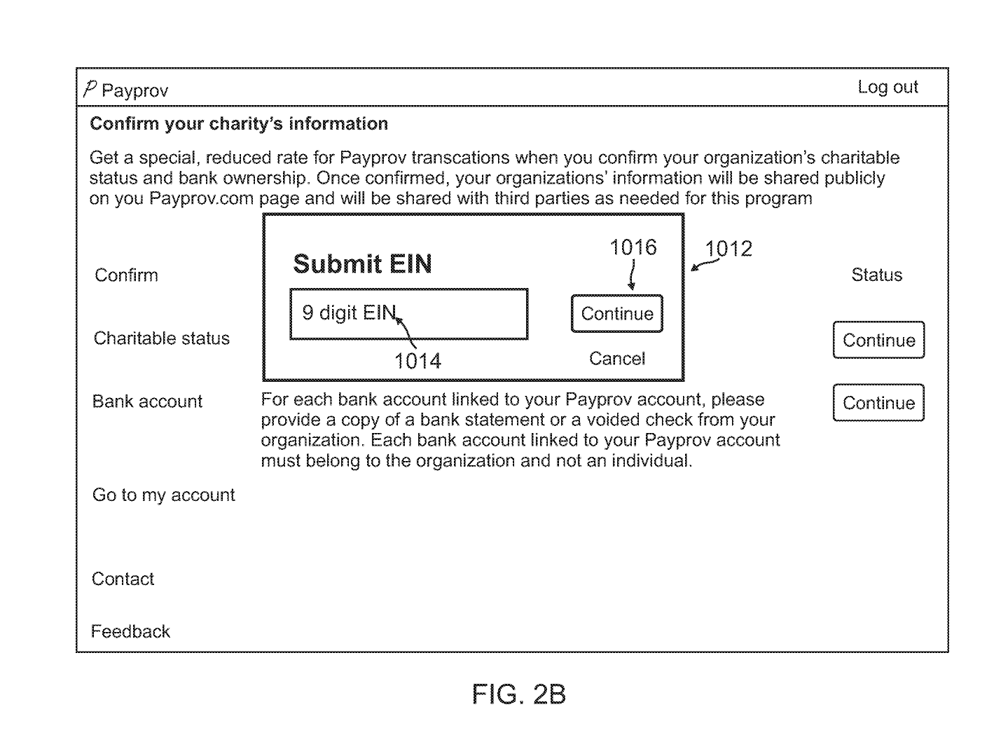

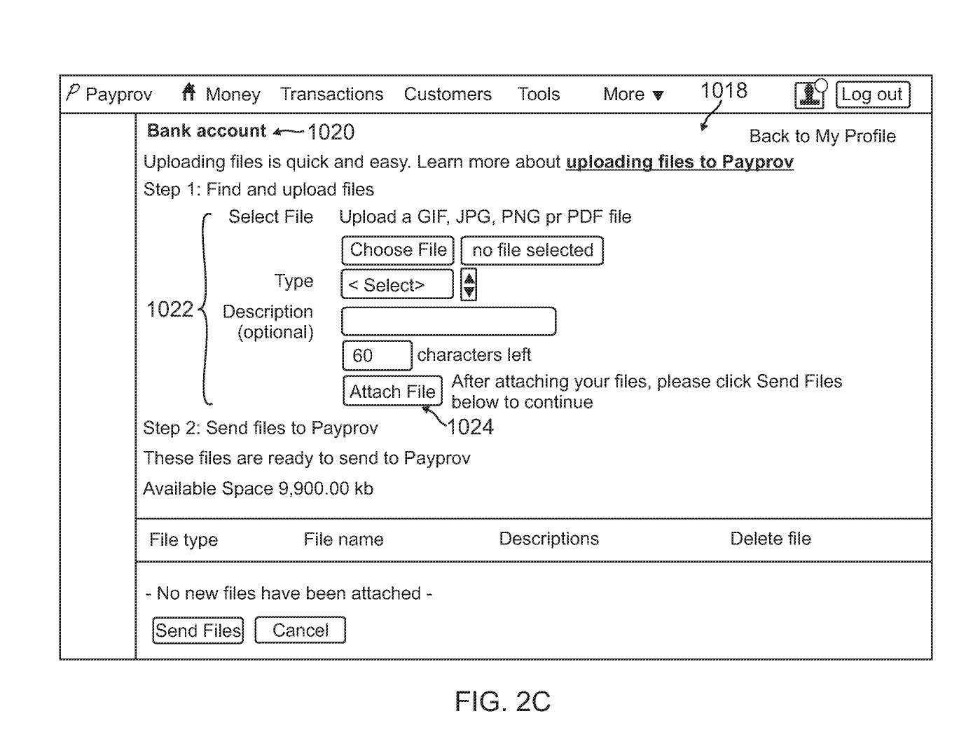

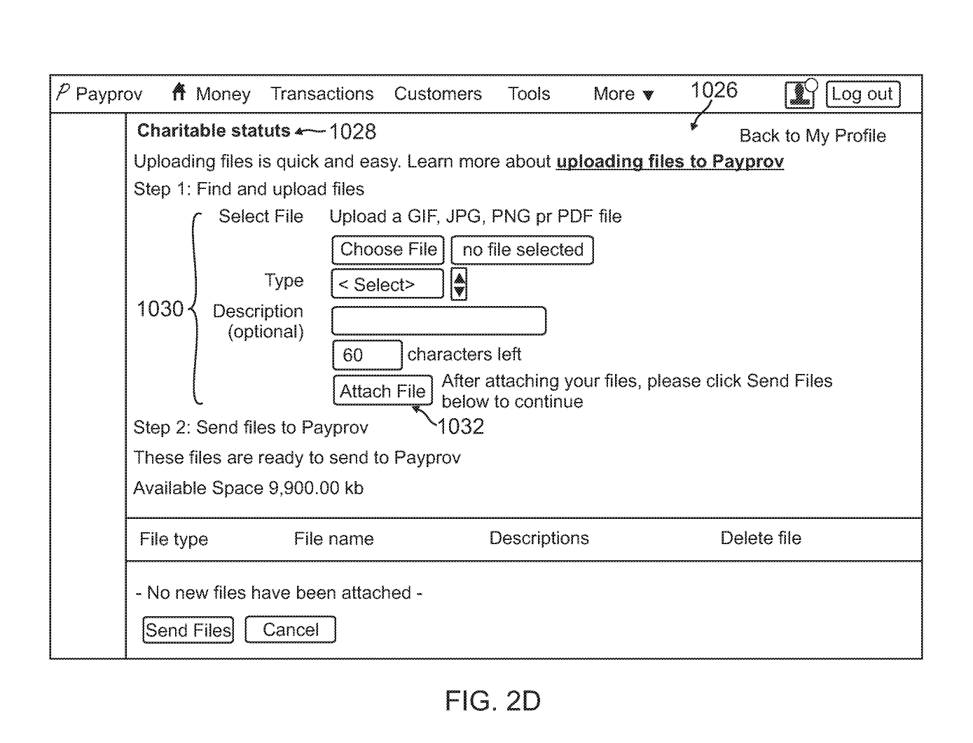

Portal interface application 140 may correspond to one or more processes to execute modules and associated specialized hardware of payment provider server 130 to receive and/or transmit information from entity device 110 for use in generating a charitable payment account and provide the information to transaction processing application 132 for use in generating a charitable payment account for a charitable entity associated with entity device 110. In this regard, portal interface application 140 may correspond to specialized hardware and/or software to provide a portal allowing for establishment of a charitable payment account for the charitable entity associated with entity device 110. For example, portal interface application 140 may access a request to establish a charitable payment account from the charitable entity associated with entity device 110 and provide a portal interface for display using entity device 110. In other embodiments, the entity may already have a payment account, and may wish to verify the payment account as charitable by providing information that identifies and entity and charitable. Such interfaces may include interfaces for receiving registration and charity information, which may be used to determine whether the charitable entity is a valid charity and whether a financial account of the charitable entity is actually linked to the charitable entity and not some other or fraudulent party. Thus, portal interface application 140 may provide the portal interfaces over a network connection to entity device 110, which may be displayed through a web browser retrieving website data for payment provider server 130 or dedicated application for payment provider server 130. For example, the portal interfaces described herein may include those presented in FIGS. 2A-2D.

Portal interface application 140 may receive the charity information and determine whether the charity is a valid charity based on accessible information. For example, the charity information may be compared to known valid charities, tax information, governing law, and/or other available information to determine whether the charitable entity is a valid charity. Thus, portal interface application 140 may access one or more databases including charitable information for charities, which includes one or more parameters that determine whether an entity is charitable. For example, the charitable information may include charity identifiers and tax statuses, charitable causes, other charities receiving donations, and other types of information used to determine whether and entity qualifies as a charity. Moreover, portal interface application 140 may further determine whether a financial account supplied by the charitable entity during registration is actually linked to the charitable entity so that the charitable entity receives donations and funding disbursed from the charitable payment account to the financial account. For example, portal interface may require whether a bank account linked to the charitable payment account established and services by payment provider server 130 is actually linked to the charity (e.g., not fraudulently to another individual or business) and that the use of the bank account is for a charitable purpose (e.g., for the stated purpose of the charity). In this regard, a fraudulent individual may provide information for another charity but link the payment account to their own bank account or otherwise use funds in the payment account for non-charitable reasons. Thus, in order prevent such fraudulent activity, the entity establishing or confirming the charitable payment account may be required to link a bank account to provide collateral if the entity is not acting charitably and/or allow review of the bank account to establish a nexus to the charity. If the charity information is correct, transaction processing application 132 may be used to establish the charitable payment account.

Transaction processing application 132 may correspond to one or more processes to execute modules and associated specialized hardware of payment provider server 130 to receive and/or transmit information from entity device 110 for establishing payment accounts, as well as processing and completing of one or more funding transactions initiated using the payment accounts. In this regard, transaction processing application 132 may correspond to specialized hardware and/or software to establish payment accounts, which may be utilized to send and receive payments and monetary transfers and engage in other financial transactions. A charitable entity associated with entity device 110 may establish a payment account with transaction processing application 132 by providing charity and/or financial information to payment provider server 130 and selecting an account login, password, and other security information. The charitable payment account may be used to receive online donations and funding, for example, through marketplaces and charitable funds of multiple charities. The payment account may be accessed and/or used through a browser application and/or dedicated payment application executed by entity device 110. The payment account may include registration, charity, and financial information for the charitable entity, and may be used to engage in financial transactions.

In various embodiments, payment provider server 130 includes other applications 134 as may be desired in particular embodiments to provide features to payment provider server 134. For example, other applications 134 may include security applications for implementing server-side security features, programmatic client applications for interfacing with appropriate application programming interfaces (APIs) over network 160, or other types of applications. Other applications 134 may contain software programs, executable by a processor, including a graphical user interface (GUI), configured to provide an interface to user 102 when accessing payment provider server 134. In various embodiments where not provided by transaction processing application 132, other applications 134 may include connection and/or communication applications, which may be utilized to communicate information to over network 160.

Additionally, payment provider server 130 includes database 136. As previously discussed, the charitable entity corresponding to contributor device 150 may establish one or more payment accounts with payment provider server 130. Payment accounts in database 136 may include charity information, such as name, address, birthdate, payment/funding information, additional user financial information, and/or other desired user data. The charitable entity may link to their respective payment accounts through an account, user, merchant, and/or device identifier. Thus, when an identifier is transmitted to payment provider server 130, e.g. from entity device 110 and/or contributor device 150, a payment account belonging to the charitable entity may be found.

In various embodiments, payment provider server 130 includes at least one network interface component 138 adapted to communicate entity device 110, home device 130, and/or contributor device 150 over network 160. In various embodiments, network interface component 138 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Contributor device 150 may be maintained, for example, by a contributor to a charity, such as a personal user, business, or government entity that wishes to provide donations and funding to a charity. In this regard, contributor device 150 may include a device having processing applications, which may be configured to interact with entity device 110 and/or payment provider server 130 to facilitate charitable contributions to the charitable entity's payment account. Contributor device 150 may be implemented using any appropriate hardware and software configured for wired and/or wireless communication with entity device 110 and/or payment provider server 130. For example, in one embodiment, contributor device 150 may be implemented as a single or networked personal computer (PC), a smart phone, laptop computer, wearable computing device, and/or other types of computing devices at a merchant location capable of transmitting and/or receiving data. Although a merchant device is shown, the merchant device may be managed or controlled by any suitable processing device. Although only one merchant device is shown, a plurality of merchant devices may function similarly.

Contributor device 150 of FIG. 1 contains a payment application 152, other applications 154, a database 156, and a communication module 158. Payment application 152 and other applications 154 may correspond to processes, procedures, and/or applications executable by a hardware processor, for example, a software program. In other embodiments, contributor device 150 may include additional or different modules having specialized hardware and/or software as required.

Payment application 152 may correspond to one or more processes to execute modules and associated devices of communication device 110 to provide donations to a charitable entity associated with entity device 110. In this regard, payment application 152 may correspond to specialized hardware and/or software utilized by a contributor associated with entity device 110 to provide a donation and/or funding to the charitable entity through payment provider server 130. In this regard, payment application 152 may correspond to a browser application or dedicated application that may access a marketplace to engage in transactions, a fund of multiple charities, and/or a website of the charitable entity or payment provider server 130 in order to initiate a funding transaction. Payment application 152 may receive a request to provide the funding transaction or may initiate the request. Payment application 152 may display the information for the charitable entity as well as the transaction information for the donation/funding. Payment application 152 may further include a receipt or other information documenting the funding transaction.

Contributor device 150 includes other applications 154 as may be desired in particular embodiments to provide features to contributor device 150. For example, other applications 154 may include security applications for implementing client-side security features, programmatic client applications for interfacing with appropriate application programming interfaces (APIs) over network 160, or other types of applications. Other applications 154 may also include email, texting, voice and IM applications that allow a user to send and receive emails, calls, texts, and other notifications through network 160. In various embodiments, other applications 154 may include financial applications, such as banking, online payments, money transfer, or other applications associated with payment provider server 130. Other applications 134 may contain software programs, executable by a processor, including a graphical user interface (GUI) configured to provide an interface to the user.

Contributor device 150 may further include database 156 which may include, for example, identifiers such as operating system registry entries, cookies associated with payment application 152 and/or other applications 154, identifiers associated with hardware of contributor device 150, or other appropriate identifiers, such as identifiers used for payment/user/device authentication or identification. Identifiers in database 156 may be used by a payment/credit provider, such as payment provider server 130, to associate contributor device 150 with a particular account maintained by the payment/credit provider. Database 156 may further include a funding transaction and associated information for a donation of funding of a charitable entity associated with entity device 110.

Contributor device 150 includes at least one communication module 158 adapted to communicate with entity device 110 and/or payment provider server 130. In various embodiments, communication module 158 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Network 160 may be implemented as a single network or a combination of multiple networks. For example, in various embodiments, network 160 may include the Internet or one or more intranets, landline networks, wireless networks, and/or other appropriate types of networks. Thus, network 160 may correspond to small scale communication networks, such as a private or local area network, or a larger scale network, such as a wide area network or the Internet, accessible by the various components of system 100.

FIG. 2A is an exemplary portal interface to confirm a charitable status and bank account for an entity, according to an embodiment. In this regard, FIG. 2A includes a portal interface accessible through a web browser application or dedicated application executing on a computing device system. The portal interface may provide one or more interface fields for entry of data for confirming a charity for use of a charitable payment account and associated benefits.

Thus, FIG. 2A includes an interface 1000 having a portal page 1002 for confirming a charity's information. Using portal page 1002, a user may provide information for a charitable status 1004. For example, description 1006 may list charitable information 1006 necessary to confirm charitable status 1004, such as an EIN and/or other requested information. Moreover, portal page 1002 may allow a charity to further provide information on a bank account 1008 for purposes of confirming that payments received are utilized for a charity and/or charitable purpose. Thus, portal page 1002 may further list bank account information 1010 that may be requested to confirm a charity's bank account and/or online charitable payment account with a payment provider. In certain embodiments, the charity's bank account may be linked to the online charitable payment account.

FIG. 2B is an exemplary portal interface to provide an employer identification number (EIN) for a charity, according to an embodiment. In this regard, FIG. 2B includes a portal interface accessible through a web browser application or dedicated application executing on a computing device system. The portal interface may provide an interface field for entry of an EIN in order to confirm an entity as having a charitable designation by a governmental agency. For example, FIG. 2B is shown with an pop-up portal interface 1012, which may correspond to a displayable window on selection of one or more options from portal page 1002 to confirm a charitable status. Pop-up portal interface 1012 includes a field 1014 for entry of an employer identification number (EIN) that may be utilized to determine whether an entity has a charitable status as provided by a governmental agency (e.g., under laws governing the jurisdiction for the entity. In this regard, on selection of a submission option 1016, a payment provider may confirm that the number entered to field 1014 is provided to a charity as recognized by the governmental agency. For example, the payment provider may access a database of records for EINs assigned to entities, such as a database accessible over the Internet and provided by the governmental agency and/or information stored to a database of the payment provider.

FIG. 2C is an exemplary portal interface to provide bank account information for a charity, according to an embodiment. In this regard, FIG. 2C includes a portal interface accessible through a web browser application or dedicated application executing on a computing device system. The portal interface may provide one or more interface fields for entry of bank account information in order to confirm a bank account is for a charity and being user for charitable purposes.

Thus, FIG. 2C includes an interface 1018 used to provide bank account information for a bank account associated with a charity. For example, the bank account may be used to pay expenses of the charity, such as salaries, supplies, and other required costs for the charity. The bank account may also buy charitable items, such as items for donation and/or use for the charitable cause. The bank account may also provide payments, donations, and/or gifts to the charitable cause. The bank account may receive payments from the payment provider, such as disbursements and deposits from a charitable payment account established and services by the payment provider. Thus, in order to provide benefits conferred to charities by the payment provider and/or benefits entitled to the charities under law, the payment provider may be required to verify the bank account. Thus, interface 1018 includes a bank account page 1020 allowing for entry of the bank account information. For example, fields 1022 may be used to upload documents for a bank account, such as a bank account statement, that may be reviewed. Fields 1022 may further include input of bank account information, such as an account number and/or routing number. The entity may then select upload option 1024 to provide the documents and/or other information to the payment provider.

FIG. 2D is an exemplary portal interface to provide charitable status information for a charity, according to an embodiment. In this regard, FIG. 2A includes a portal interface accessible through a web browser application or dedicated application executing on a computing device system. The portal interface may provide one or more interface fields for entry of data for confirming a charity for use of a charitable payment account and associated benefits. For example, and similar to interface 1018 of FIG. 2C, FIG. 2D allows for an entity to upload one or more documents and/or enter information for review by a payment provider to determine whether an entity is charitable under legal requirements governing the entity. For example, an interface 1026 includes a charity page 1028 for entry of information for the charity. An entity may upload one or more documents and/or enter information for the charity into field 1030. After selection of upload option 1032, the payment provider may review the provided information and determine whether the entity qualifies as a charity.

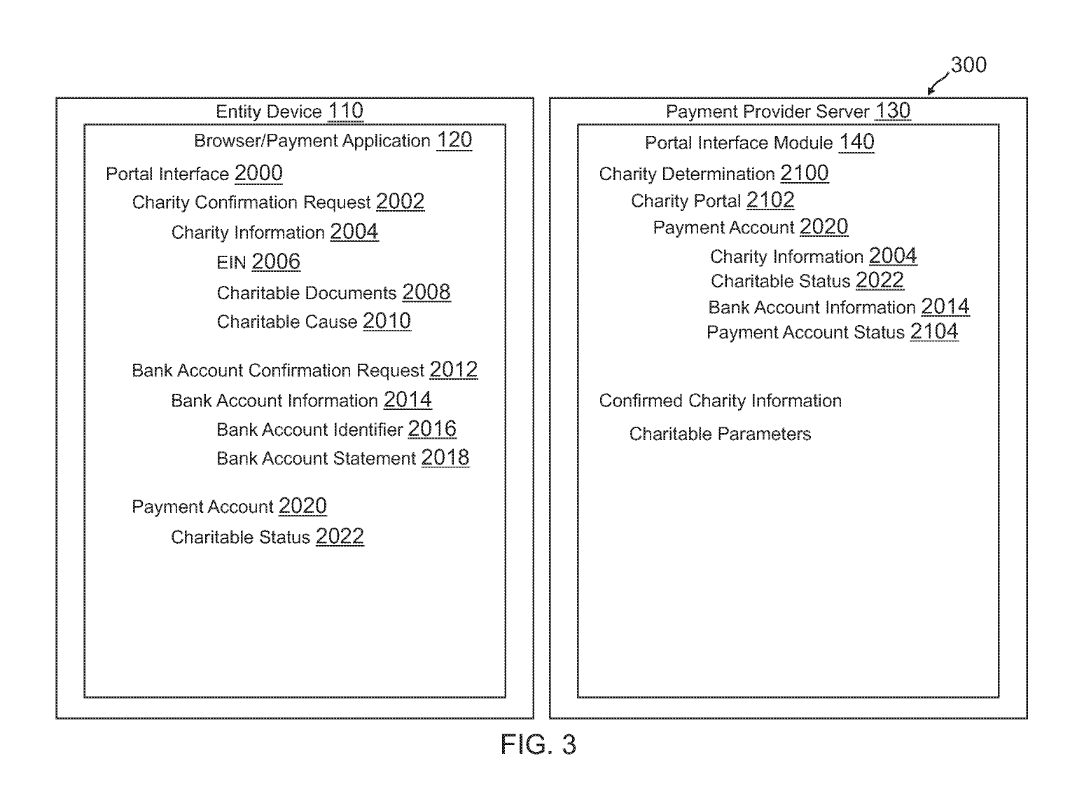

FIG. 3 is an exemplary system environment having a entity's device establishing a confirmed entity payment account with a payment provider, according to an embodiment. Environment 300 includes a entity device 110 and a payment provider server 130 corresponding generally to the devices, servers, and other computing architecture described in reference to environment 100 of FIG. 1.

Entity device 110 executes browser/payment application 120 corresponding generally to the specialized hardware and/or software modules and processes described in reference to FIG. 1. In this regard, browser/payment application 120 may be used to provide information to establish and/or verify a charitable payment account in order to receive benefits provided to the charitable payment account, such as reduced tax rates and/or account fees. Thus, browser/payment application may access a portal interface 2000, which may include one or more pages, fields, or other portal elements for entry of data to establish/verify the charitable payment account. For example, portal interface 2000 includes a charity confirmation request 2002 and a bank account confirmation request 2012 for a payment account 2020.

Charity confirmation request 2002 may request information in order to confirm a charity status for an entity. Thus, charity information 2004 may be provided by the entity in response to charity confirmation request 2002. Charity information 2004 may include various information used to confirm that the entity is a charity under governing law, which may include an EIN 2006, charitable documents 2008 (e.g., articles of incorporation or other legal documents structuring the charitable entities business, bank accounts, donations and charitable fund uses, etc.), and a charitable cause 2010. Payment provider server 130 may further provide bank account confirmation request 2012 through portal interface 2000 in order to confirm that a bank account associated with the charity is utilized by the charity and held by the charity to prevent fraudulent activity. In response to bank account confirmation request 2012, the entity may provide bank account information 2014, which may include a bank account identifier 2016, as well as a bank account statement 2018. Moreover, browser/payment application 120 may include information for the charity's payment account 2020, such as a charitable status 2022 for display to the user.

Payment provider server 130 executes portal interface module 140 corresponding generally to the specialized hardware and/or software modules and processes described in reference to FIG. 1. In this regard, portal interface module 140 may be utilized to provide portal interface 2000 output through browser/payment application 120 and process data received through portal interface 2000. For example, portal interface module 140 includes a charity determination 2100, which may include a portal 2102 displayed to the entity of entity device 110. Portal 2102 may receive information for payment account 2020 for the entity, which may include the received charity information 2004 and bank account information 2014. Using charity information 2004 and/or bank account information 2014, charitable status 2022 may be determined. Charitable status 2022 may further be determined using accessible information of parameters defining a charity, such as confirmed charity information 2106 having charitable parameters 2108. Additionally, after reviewing bank account information 2014, portal interface module 140 may determine a payment account status 2104, such as whether the payment account is a charitable payment account based on laws defining a charity and whether the payment account is linked to a charity and/or a bank account used/held by a charity.

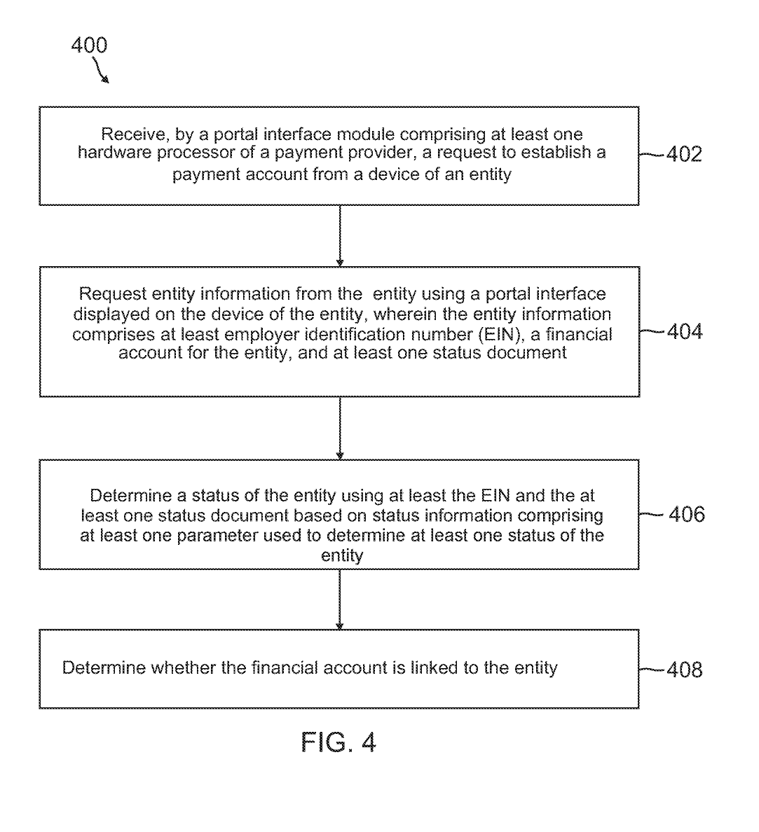

FIG. 4 is an exemplary process flowchart for to a portal interface for establishment and management of a confirmed entity payment account, according to an embodiment. Note that one or more steps, processes, and methods described herein may be omitted, performed in a different sequence, or combined as desired or appropriate.

At step 402, a request to establish a payment account is received from a device of an entity, for example, by a payment provider system. At step 404, entity information is requested from the entity using a portal interface displayed on the device of the entity, wherein the entity information comprises at least employer identification number (EIN), a financial account for the entity, and at least one status document. The entity information is received, and at step 406, a status of the entity is determined using at least the EIN and the at least one status document based on status information available from a database and comprising at least one parameter used to determine at least one status of the entity. The entity information may further include an email, and wherein the portal interface module determines whether the email is associated with the entity. The entity information required within the portal interface may be specific to a country of origin of the entity, and wherein the payment provider determines whether the entity information matches valid entity status information required in the country of origin. For example, the valid entity status information required in the country of origin may comprise compliance requirements of local laws for entities in the country of origin.

At step 408, it is further determined whether the financial account is linked to the entity. If both are determined to be correct, the payment provider may generate the payment account and/or a funding request to the payment account by the entity, for example, to utilize for the entity. In various embodiments, the payment account may receive a discounted rate fee for transactions. The payment provider may offer contributions to the payment account during transactions using the payment provider, for example, donations from other users and entities through processes and services of the payment provider. The portal interface may also provide an enrollment page for the payment account in a fund for receiving donations.

A portal interface application may further provide a management interface within the portal interface, and wherein the management interface allows the entity to manage the payment account. The management interface may include a profile for establishing information for the entity with the payment account. The management interface may also include a direct sellers form for adding direct sellers that providing funding to the entity through sales on a marketplace.

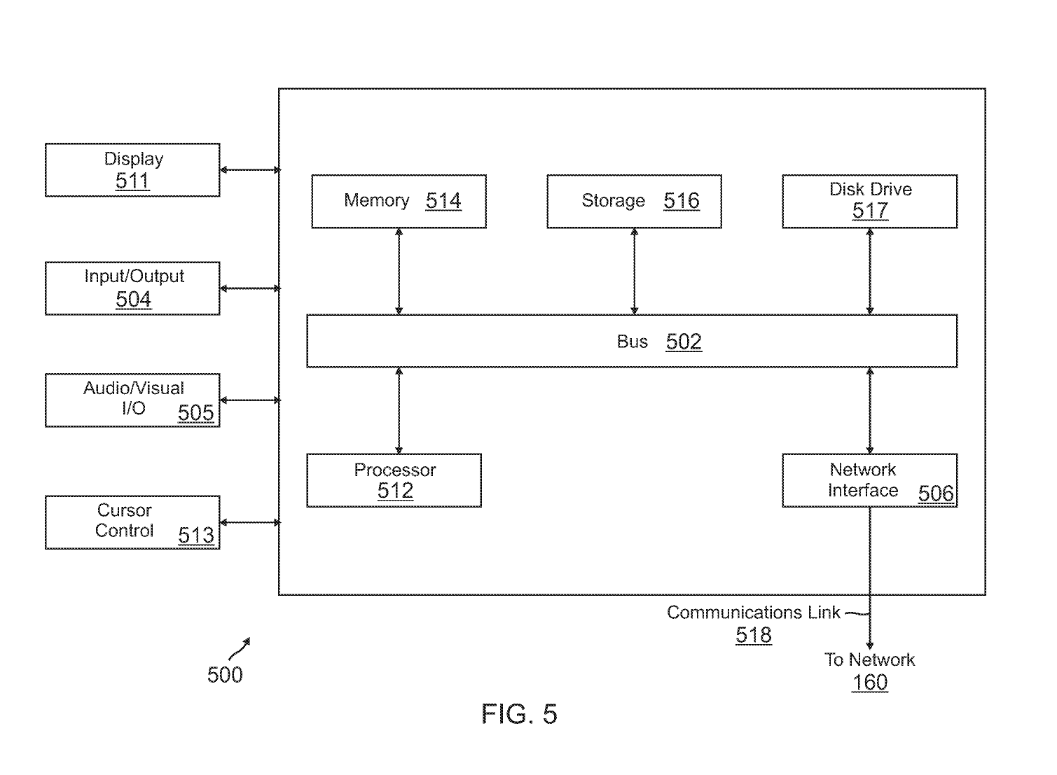

FIG. 5 is a block diagram of a computer system suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 160. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A payment provider system comprising:
a non-transitory memory storing status information comprising at least one parameter used to determine at least one status of an entity;
one or more hardware processors coupled to the non-transitory memory and configured to read instructions from the non-transitory memory to cause the payment provider system to perform operations comprising:
receiving a request to establish a payment account from a device of the entity;
requesting entity information from the entity using a portal interface displayed on the device of the entity, wherein the entity information comprises at least employer identification number (EIN), a financial account for the entity, and at least one status document for the entity,
determining a status of the entity using at least the EIN and the at least one status document based on the status information;
determining whether the financial account is linked to the entity; and
generating the payment account based on the status of the entity and whether the financial account is linked to the entity.

2. The system of claim 1, wherein the payment account receives a discounted rate fee for transactions.

3. The system of claim 1, wherein the payment provider offers contributions to the payment account during transactions using the payment provider.

4. The system of claim 1, wherein the one or more hardware processors are configured to read the instructions from the non-transitory memory to cause the payment provider system to perform the operations further comprising:
providing a management interface within the portal interface, and wherein the management interface allows the entity to manage the payment account.

5. The system of claim 4, wherein the management interface includes a profile for establishing information for the entity with the payment account.

6. The system of claim 4, wherein the management interface includes a direct sellers form for adding direct sellers that providing funding to the entity through sales on a marketplace.

7. The system of claim 1, wherein the portal interface provides an enrollment page for the payment account in a fund for receiving donations.

8. The system of claim 1, wherein the charity information further includes an email, and wherein the one or more hardware processors are configured to read the instructions from the non-transitory memory to cause the payment provider system to perform the operations further comprising:
determining whether the email is associated with the entity.

9. The system of claim 1, wherein the entity information required within the portal interface is specific to a country of origin of the entity, and wherein the one or more hardware processors are configured to read the instructions from the non-transitory memory to cause the payment provider system to perform the operations further comprising:
determining whether the entity information matches valid entity status information required in the country of origin.

10. The system of claim 9, wherein the valid entity status information required in the country of origin comprises compliance requirements of local laws for entities in the country of origin.

11. A method comprising:
receiving, by a payment provider system that comprises one or more hardware processors coupled to a non-transitory memory, a request to establish a payment account from a device of an entity;
requesting entity information from the entity using a portal interface displayed on the device of the entity, wherein the entity information comprises at least employer identification number (EIN), a financial account for the entity, and at least one status document for the entity,
determining a status of the entity using at least the EIN and the at least one status document based on status information comprising at least one parameter used to determine at least one status of the entity;
determining whether the financial account is linked to the entity; and
generating the payment account based on the status of the entity and whether the financial account is linked to the entity.

12. The method of claim 11, wherein the payment account is further associated with a funding request by the entity.

13. The method of claim 12, wherein the funding request comprises a request to receive an amount for a use by the entity.

14. The method of claim 13, wherein the use by the entity comprises one of a purchase of an item by the entity, payment of a debt owed by the entity, and a donation by the entity.

15. The method of claim 11, further comprising:
providing a management interface within the portal interface, wherein the management interface allows the entity to manage the payment account, wherein the management interface includes a profile for establishing information for the entity with the payment account.

16. The method of claim 14, wherein the management interface includes a direct sellers form for adding direct sellers that providing funding to the entity through sales on a marketplace.

17. The method of claim 11, wherein the portal interface provides an enrollment page for the payment account in a fund for receiving donations.

18. The method of claim 11, wherein the entity information further includes an email, and wherein the method further comprises:
determining whether the email is associated with the entity.

19. The method of claim 11, wherein the entity information required within the portal interface is specific to a country of origin of the entity, and wherein the method further comprises:
determining whether the entity information matches valid entity status information required in the country of origin.

20. A non-transitory machine-readable medium having stored thereon machine-readable instructions executable to cause a machine to perform operations comprising:
receiving, by a payment provider system that comprises one or more hardware processors coupled to a non-transitory memory, a request to establish a payment account from a device of an entity;
requesting entity information from the entity using a portal interface displayed on the device of the entity, wherein the entity information comprises at least employer identification number (EIN), a financial account for the entity, and at least one status document for the entity,
determining a status of the entity using at least the EIN and the at least one status document based on status information comprising at least one parameter used to determine at least one status of the entity;
determining whether the financial account is linked to the entity; and
generating the payment account based on the status of the entity and whether the financial account is linked to the entity.
